(19) United States
(12) Patent Application Publication
(10) Pub. No.: US 2021/0331356 A1
(43) Pub. Date: Oct. 28, 2021

(54) APPARATUS FOR COMPRESSION MOULDING CONCAVE OBJECTS

(71) Applicant: SACMI COOPERATIVA MECCANICI IMOLA SOCIETA' COOPERATIVA, 40026 IMOLA (BOLOGNA) (IT)

(72) Inventors: FIORENZO PARRINELLO, MEDICINA (IT); FABRIZIO PUCCI, CASTEL GUELFO DI BOLOGNA (IT)

(21) Appl. No.: 17/284,288

(22) PCT Filed: Oct. 3, 2019
(86) PCT No.: PCT/IB2019/058425

§ 371 Date: Apr. 9, 2021

(30) Foreign Application Priority Data
Oct. 11, 2018 (IT) 102018000009342

(51) Int. Cl. B29C 43/34; B29C 31/04; B29C 43/08; B29C 43/58; B29C 48/00; B29C 48/21; B29C 48/355

(52) U.S. Cl. CPC B29C 43/34; B29C 31/048; B29C 43/08; B29C 43/58; B29C 48/0011; B29C 48/21; B29L 2031/7132; B29C 2043/3433; B29C 2043/5875; B29C 2043/3472; B29C 2043/585; B29C 2043/5891; B29C 48/355

(57) ABSTRACT

An apparatus comprises:
a dispensing device for dispensing at least one polymeric material;
a severing element for severing a dose of polymeric material from the polymeric material dispensed by the dispensing device;
a transport element for transporting the dose;
a mould comprising a male mould element and a female mould element, the female mould element being positioned above the male mould element.

The transport element is configured to perform a first movement by moving along a path directed from the dispensing device towards the mould, so as to bring the dose to the mould. Moreover, the transport element is configured to perform, in addition to the first movement, a second movement by rotating about an axis, so as to turn the dose from a first orientation with which the dose is received by the transport element, to a second orientation with which the dose is released by the transport element onto the male mould element.

The invention relates to an apparatus for manufacturing, by compression moulding, concave objects, in particular containers.

The apparatus according to the invention may be used, for example, for producing capsules intended to contain a powdered or granular substance such as coffee or the like, arranged for preparing beverages or other food product fluids. Alternatively, the apparatus according to the invention may be used for manufacturing preforms intended to be subjected to a blow moulding process or to a stretch blow moulding process in order to form containers such as bottles. More generally, the apparatus according to the invention may be used for manufacturing containers of any type, such as, for example cups, jars or bowls.

The apparatus according to the invention allows to manufacture concave objects made of a single material, starting from any polymeric material which can be subjected to compression moulding. Alternatively, the apparatus according to the invention allows to manufacture concave objects having a multilayer structure, i.e. having a wall formed by two or more layers placed side by side, the layers being made of polymeric materials different from each other.

Apparatuses are known for manufacturing objects by compression moulding metered quantities of polymeric material. The prior art apparatuses comprise an extruder for dispensing a polymeric material and a plurality of moulds, each of which comprises a male element provided with a punch and a female element provided with a cavity. The prior art apparatuses further comprise a plurality of transport elements, each of which transports a dose of polymeric material from the extruder to a mould. In the moulds of the known apparatuses, the female element is located beneath the male component, in such a way that the cavity of the female element faces upwards. The dose of polymeric material, after being severed from the extruder, is released inside the cavity of the female element by the transport element, which drops the dose from above towards the bottom of the cavity. Subsequently, the male element and the female element are moved towards each other to deform the dose, thereby shaping the dose according to the desired geometry.

Although prior art apparatuses are capable of working in a satisfactory manner in a large number of cases, they have several drawbacks especially when it is necessary to compression mould multi-layer doses, that is to say, doses comprising a plurality of layers made from materials different from each other. In this case, positioning the dose correctly inside the mould is a particularly critical operation.

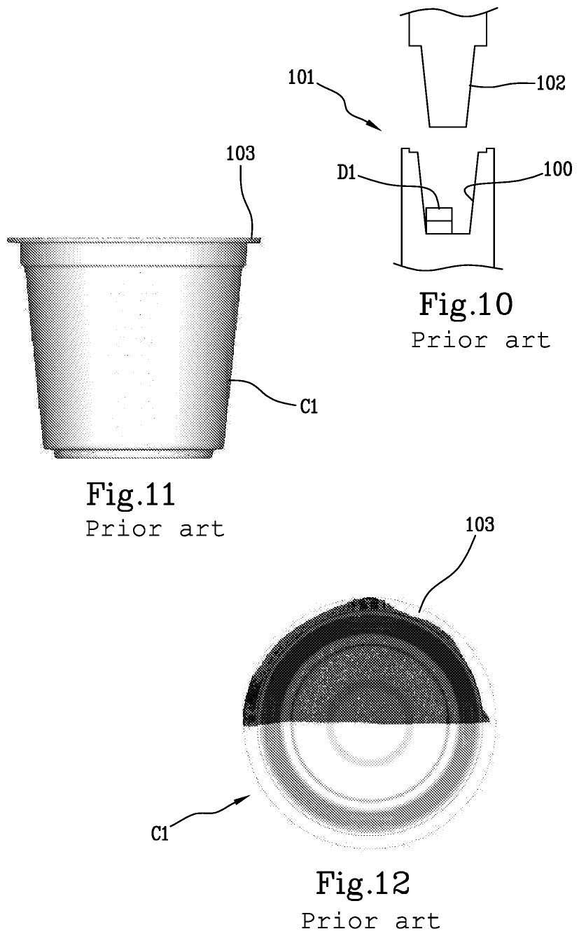

The situation shown in FIG. 10 should be considered, for example. In this case a dose D1 has been deposited inside a cavity 100 of a mould 101, the mould 101 further comprising a punch 102 positioned above the cavity 100. The dose D1 has a multilayer structure and comprises two outer layers between which an intermediate layer is interposed, the intermediate layer being made of a material having oxygen barrier properties. In order that the dose D1, after being released by the transport element, can reach the bottom of the cavity 100 without interacting with the side walls of the cavity 100, the dose D1 has a width significantly less than the diameter of the bottom of the cavity 100. It may therefore happen that, as shown in FIG. 10, the dose D1 is arranged in a non-centered position on the bottom of the cavity 100, that is to say, the dose D1 is arranged in a misaligned position relative to a vertical axis of the cavity 100.

FIG. 11 shows, in an enlarged scale, a container C1 produced in the mould 101 starting from the dose D1, positioned as shown in FIG. 10. The container C1 may be, for example, a coffee capsule. FIG. 12 shows a top view of the container C1, in which the distribution of the material forming the intermediate layer of the dose D1 (that is to say, the material having barrier properties) inside the container C1 is indicated in the upper half, in black. It can be seen clearly that the barrier material is distributed in a non-uniform manner, in particular asymmetrically, along a flange 103 of the container C1. This is a consequence of the non-centered position of the dose D1 in the cavity 100.

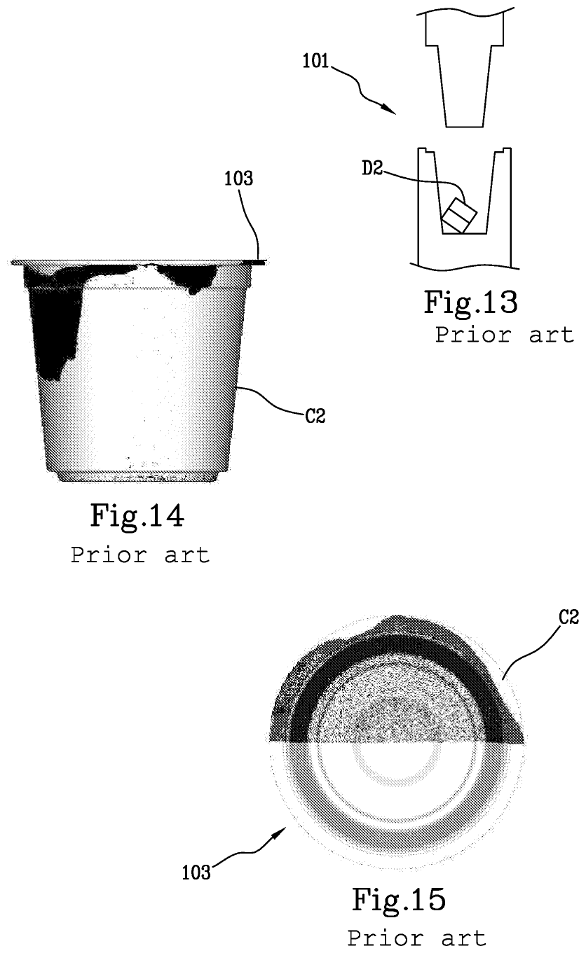

FIG. 13 shows a mould 101, similar to that of FIG. 10, inside which a dose D2 has been deposited. The dose D2 is incorrectly positioned in a tilted manner relative to a vertical axis of the cavity 100. In this case, the dose D2 is not only positioned in a non-centered manner inside the cavity 100, but a portion of the dose 102 is resting on the bottom of the cavity 100, whilst a further portion of the dose 102 is resting against a side wall of the cavity 100, so that the intermediate layer of the dose D2 is not parallel to the bottom of the cavity 100.

FIGS. 14 and 15 show that, in the container C2 obtained from the dose D2, not only the barrier material is distributed non-uniformly, in particular asymmetrically, along the flange 103, but the barrier material also appears on the surface of the side wall of the container C2, as indicated by the black spots in FIG. 13. This is once again a consequence of the incorrect position of the dose D2 in the mould 101.

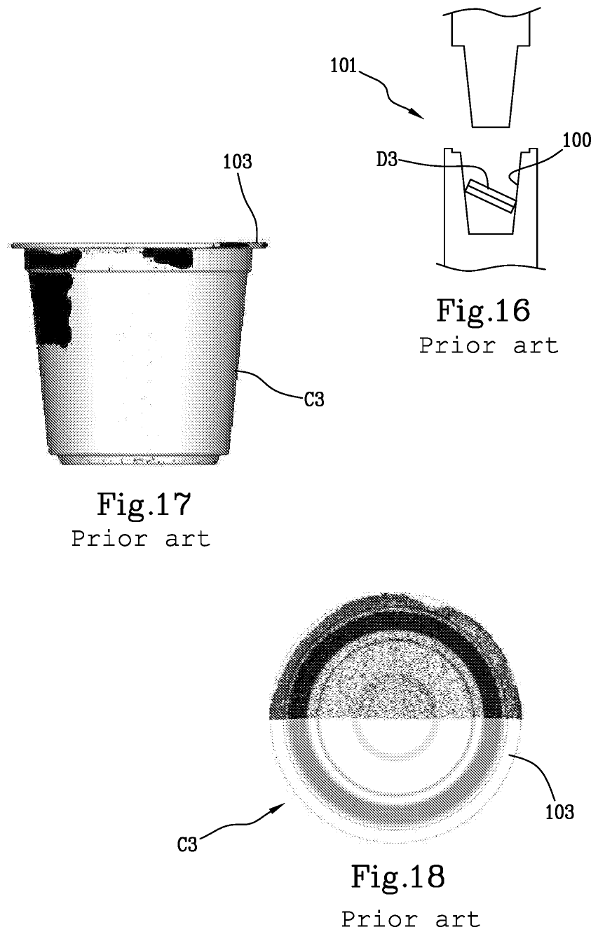

FIG. 16 shows a mould 101, similar to that of FIGS. 10 and 13, in which a dose D3 has been inserted, the dose D3 having a width very close to the diameter of the bottom of the cavity 100, for example slightly larger than the diameter of the bottom. In this case, the dose D3, while falling into the cavity 100, arranges itself in a tilted position relative to the bottom of the cavity 100, and rests on the side walls of the cavity 100 without being able to reach the bottom. This causes, on the container C3 formed starting from the dose D3, an unacceptably asymmetrical distribution of the barrier material, which not only is unable to reach the entire perimeter of the flange 103, but also appears on the outer surface of some portions of the side wall of the container C3, as shown in FIGS. 17 and 18.

The examples described above show that the known apparatuses can, in certain cases, produce defective objects because the dose has not been correctly positioned inside the mould. It should be noted that, in the prior art apparatuses, it is particularly difficult, if not impossible, to check if the dose has been correctly positioned inside the mould.

Another defect that the prior art apparatuses can have is that a spot can be generated, on the formed object, at the point where the polymeric material of the dose (be it single layer or multi-layer) firstly touches the mould. Indeed, the portion of the dose which firstly touches the mould cools down more rapidly than the surrounding portions of the dose, and consequently crystallises in different ways relative to the surrounding portions of the dose. This generates a spot having features different from the features of the surrounding zones, both from a physical-chemical point of view and from the point of view of structural morphology. In the known moulds, the spot is arranged on the surface which delimits, from the outside, a bottom wall of the moulded object, and is easily visible to the user.

An object of the invention is to improve the apparatuses for producing objects by compression moulding doses of polymeric material, in particular but not exclusively having a multilayer structure.

A further object is to provide an apparatus for compression moulding doses comprising at least one polymeric material, in which each dose can be correctly positioned inside the mould.

Another object is to provide an apparatus for compression moulding doses comprising at least one polymeric material, in which possible incorrectly positioned doses inside the mould can be early detected.

A further object is to provide an apparatus for compression moulding doses comprising at least one polymeric material, which makes it possible to obtain objects in which the surfaces intended to remain visible, during use, are substantially free of visible defects.

Another object is to provide an apparatus for compression moulding multi-layer doses, which reduces the risks of obtaining an object having a non-uniform distribution, in particular an asymmetrical distribution, of the layers of each dose.

According to the invention, there is provided an apparatus comprising:
a dispensing device for dispensing at least one polymeric material;
a transport element for transporting a dose of polymeric material dispensed by the dispensing device;
a mould comprising a male mould element and a female mould element, the female mould element being positioned above the male mould element;
   wherein the transport element is configured to perform a first movement by moving along a path directed from the dispensing device towards the mould, so as to bring the dose to the mould,
   and wherein the transport element is configured to perform, in addition to the first movement, a second movement by rotating about an axis, so as to turn the dose from a first orientation with which the dose is received by the transport element, to a second orientation with which the dose is released by the transport element onto the male mould element.

Owing to the invention, it is possible to position more correctly the dose in the mould with respect to the prior art. Indeed, the transport element, by turning the dose from the first orientation to the second orientation, allows the dose to be delivered to the mould very close to the male mould element. This prevents the dose from falling freely for significant distances, which allows a better control of the position of the dose relative to the male mould element. Consequently, the risks are reduced that the dose is positioned in a non-centred or asymmetrical manner inside the mould.

Moreover, since the dose is released onto the male mould element, the portion of the dose which touches firstly the mould is that which is in contact with the male mould element, and is therefore intended to form an inner surface of the moulded object. Therefore, if spots are formed on the moulded object, due to the initial contact between the dose and the mould, these spots are located inside the moulded object. They do not remain visible during use of the object, which makes it possible to improve quality of the object.

The female the mould is provided with a cavity, inside which the male mould element is intended to be inserted for shaping the polymeric material, the cavity facing downwards.

The transport element is configured to perform the second movement while the transport element performs the first movement.

The first movement of the transport element may be a movement along a closed path extending at least partly about an axis, for transporting the dose from the dispensing device towards the mould.

The axis about which the transport element rotates during the second movement may be arranged transversely to the axis of the closed path, along which the transport element moves during the first movement.

In an embodiment, in the second orientation, the dose lies on a substantially horizontal plane.

The transport element can thereby release the dose, arranged substantially horizontally, on a surface which delimits the male mould element from above.

This surface may be substantially horizontal.

This prevents the dose from arranging itself in a tilted position, which could cause the mould to be non-uniformly filled.

In an embodiment, in the first orientation, the dose lies on a substantially vertical plane.

In this case, the dose leaves the extruder along a substantially vertical direction, and is collected by the transport element without undergoing significant modifications of its orientation.

The dispensing device may comprise an extrusion device for dispensing a continuous extruded structure made of a single material, from which the doses are subsequently separated.

In an alternative embodiment, the dispensing device may comprise a co-extrusion device for dispensing a continuous multilayer co-extruded structure, comprising at least two layers of different materials.

In an embodiment, the apparatus comprises at least one severing element for severing a dose of polymeric material from the polymeric material dispensed by the dispensing device.

The severing element may be supported by the transport element.

Alternatively, the severing element may be located upstream of the transport element and separated from the transport element.

In an embodiment, the severing element is configured to sever doses having a parallelepiped conformation from a continuous structure dispended by the dispensing device.

The doses having a parallelepiped conformation are particularly easy to be obtained, simply by cutting a flat extrudate, without generating waste.

Moreover, the doses having a parallelepiped conformation are delimited by flat faces. More specifically, a face of the dose intended to rest on the male mould element is in this case flat. It is thus possible to obtain a good stability in the position of the dose on the male mould element, even though the latter is by definition free of containment side walls.

The stability in positioning the dose on the male mould element is further increased if the male mould element is delimited from above by a transverse surface defining a flat resting zone for supporting the dose.

In an embodiment, the apparatus comprises a control device, in particular a vision system which may be provided with a video camera, for checking the position of the dose on the male mould element.

More specifically, the vision system is configured to check if the dose has been released in a centred position on the male mould element.

Alternatively or in addition to the above, the vision system may be configured to check whether the dose, after being released by the transport element, is positioned in a tilted manner, in particular not horizontally, on the male mould element, or more precisely on an upper surface which delimits the male mould element from above.

The vision system allows to check the position of the dose relative to the male mould element when the mould is still open, in particular immediately after the dose has been released onto the male mould element. In this condition, the female mould element is at a level higher than the male mould element and does not obstruct the vision system whilst the latter checks the position of the dose.

It is thus possible to quickly determine if the dose is correctly positioned, and, if necessary, to stop the apparatus before the dose is shaped.

The invention can be better understood and implemented with reference to the accompanying drawings which illustrate a non-limiting example embodiment thereof and in which:

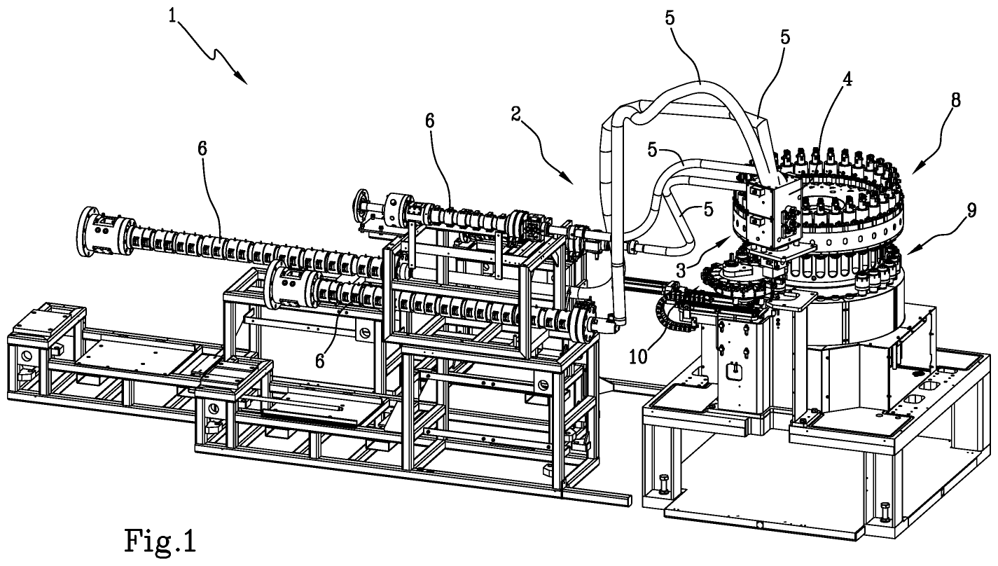

FIG. 1 is a perspective view of an apparatus for producing objects by compression moulding;

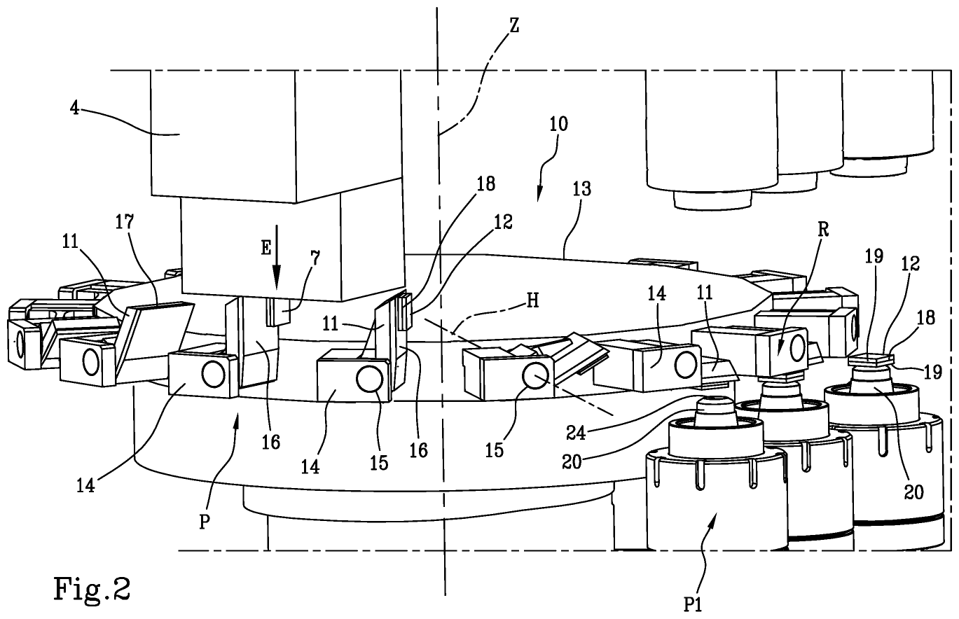

FIG. 2 is a perspective and enlarged view showing a portion of the apparatus of FIG. 1;

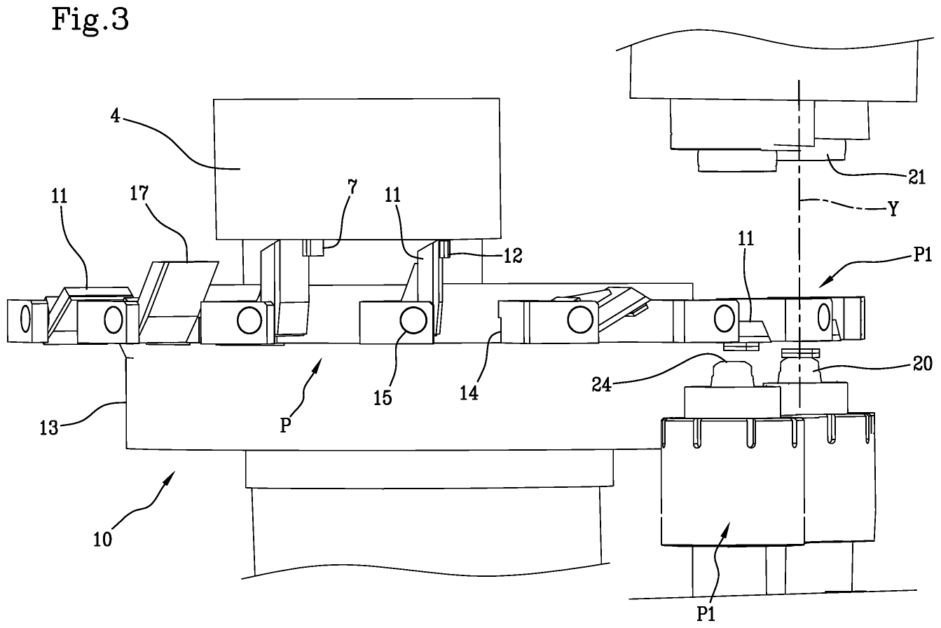

FIG. 3 is a side view of the portion of apparatus of FIG. 2;

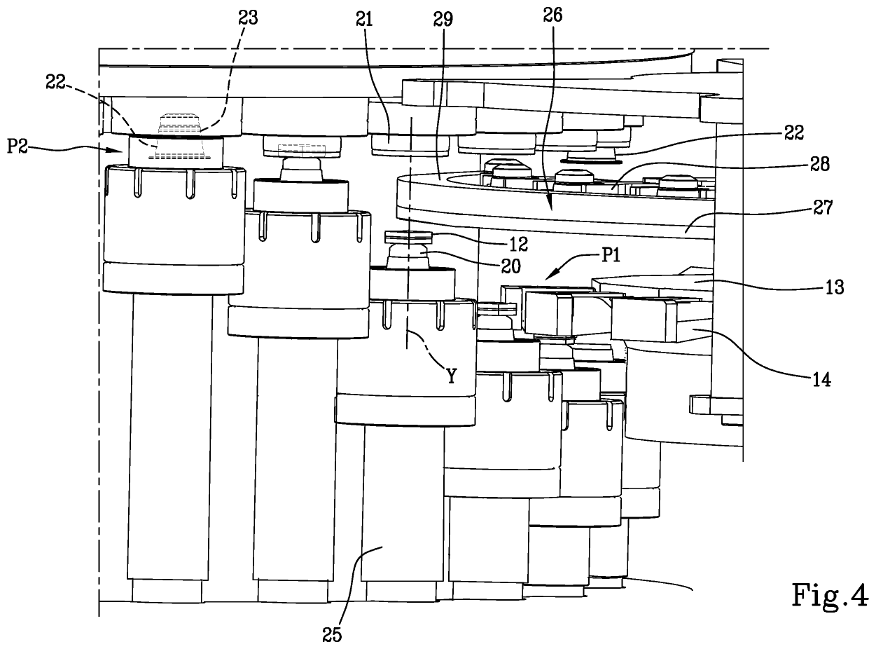

FIG. 4 is a perspective and enlarged view showing a further portion of the apparatus of FIG. 1;

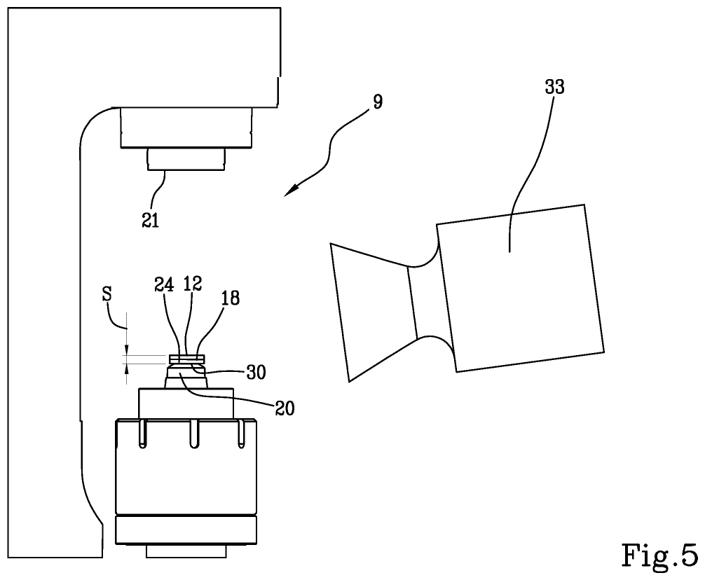

FIG. 5 is a schematic side view showing an alternative embodiment of a mould like those of the apparatus of FIG. 1, the mould being provided with a control device for controlling the position of the dose, in a configuration in which the dose is positioned correctly on a male mould element;

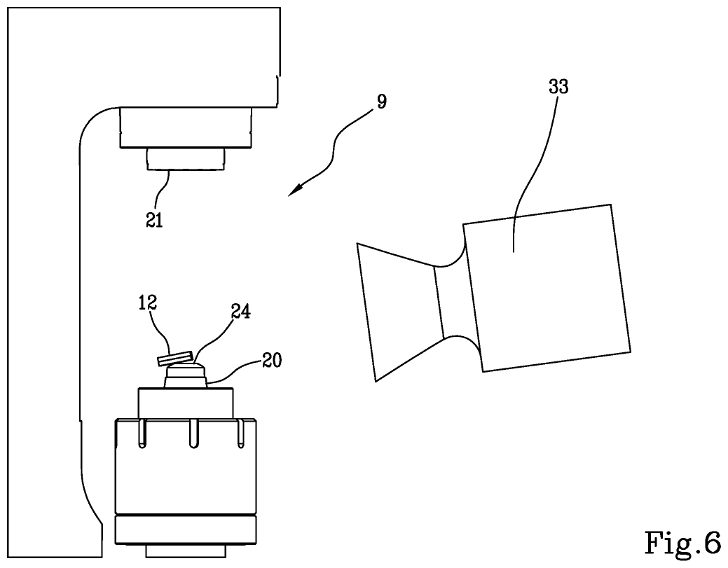

FIG. 6 is a view like that of FIG. 5, in a configuration in which the dose is positioned in an incorrect manner on a male mould element;

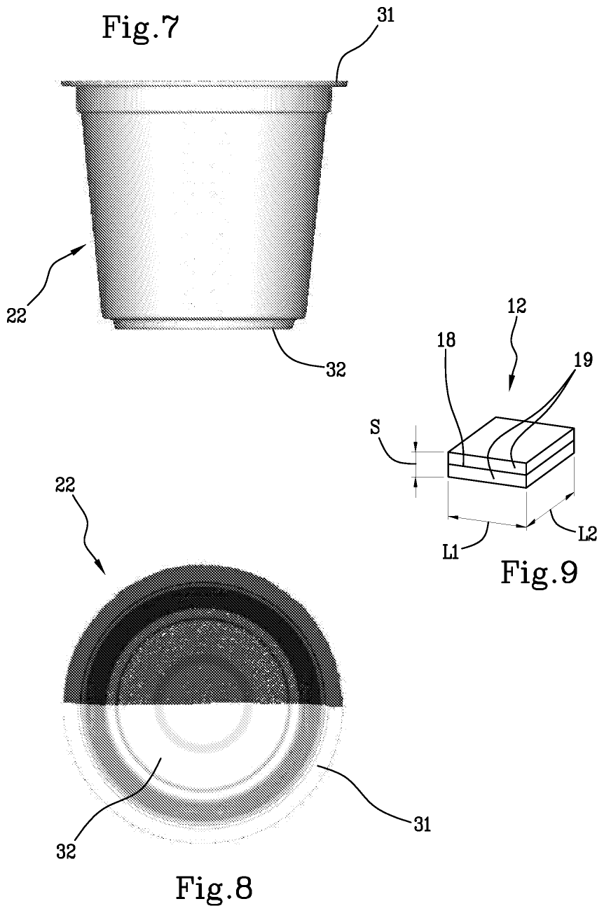

FIG. 7 is a side view of a container produced by the apparatus of FIG. 1;

FIG. 8 is a top view of the container of FIG. 7, in the upper half of which is shown, in black, the distribution of a barrier layer in the moulded container;

FIG. 9 is a schematic perspective view of a portion of a dose which can be processed by the apparatus of FIG. 1;

FIGS. 10, 13 and 16 are schematic side views, each showing a mould according to the prior art, inside of which there is an incorrectly positioned dose;

FIGS. 11, 14 and 17 are side views like that of FIG. 7, showing corresponding containers obtained respectively by the moulds of FIGS. 10, 13 and 16;

FIGS. 12, 15 and 18 are side views like that of FIG. 8, showing corresponding containers obtained respectively by the moulds of FIGS. 10, 13 and 16.

FIG. 1 shows an apparatus 1 for producing objects made of polymeric material by compression moulding. The objects which the apparatus 1 allows to produce may be concave objects, particularly containers, such as, for example capsules for coffee or other substances containing ingredients which can be extracted by means of a fluid, or jars, cups or bowls. Alternatively, the apparatus 1 may be used for producing preforms intended to form containers by blow-moulding.

The apparatus 1 comprises a dispensing device 2 for dispensing at least one polymeric material. In the example shown, the dispensing device 2 comprises a co-extrusion device 3 for dispensing a continuous coextruded structure comprising a plurality of layers of polymeric materials different from each other.

The co-extrusion device 3 may comprise a co-extrusion head 4 in which a plurality of feed ducts 5 end, each of the feed ducts 5 being intended to feed the co-extrusion head 4 with a corresponding polymeric material. Each feed duct 5 communicates with a respective extruder 6, in which the corresponding polymeric material to be extruded is introduced, particularly in the form of granules, for example through a hopper, not illustrated.

The co-extrusion device 3 may be in particular configured to dispense a continuous coextruded structure comprising a central functional layer, interposed between two outer layers. The central functional layer may comprise a material having barrier properties, for example to gases and/or oxygen and/or light. The outer layers, which may be equal to each other or different from each other, can be made with materials intended to give the desired mechanical and/or aesthetic properties to the objects which will be obtained. Respective auxiliary layers can be interposed between the outer layers and the central layer, for example, a layer of compatibilization material having the purpose of improving adhesion between the central layer and the outer layers.

In the example shown there are four extruders 6. The two smaller extruders 6, i.e. the extruders 6 communicating with the feed ducts 5 having a smaller diameter, are arranged to dispense, respectively, the barrier material and the compatibilization material. The two larger extruders 6, i.e. the extruders 6 communicating with the feed ducts 5 having a larger diameter, are arranged to dispense the materials of the outer layers. An extruder 6 for each outer layer is provided, so as to be able to vary the features of one outer layer independently from those of the other outer layer. This allows, for example, to use two materials different from each other for the two outer layers, such as a virgin polymeric material and, respectively, a recycled polymeric material, or a softer material and, respectively, a harder one. In addition or alternatively to the above, by using two different extruders 6 for the outer layers it is possible to generate a continuous coextruded structure in which the outer layers have different thicknesses from each other, so as to modify the position of the intermediate layer relative to the centre line of the continuous coextruded structure.

In an alternative embodiment that is not illustrated, the dispensing device 2 may comprise an extrusion device arranged to extrude a continuous structure made of a single material, that is to say, made with a single polymeric material instead of a plurality of polymeric materials different from each other.

The dispensing device 2 is provided with an outlet opening having a rectangular or square shape, so as to dispense a continuous structure conformed as a strip having a cross-section which is rectangular or square. If the cross-section of the strip is rectangular, the base of the rectangle may be much greater than the height, even if this condition is not necessary.

In the example shown, as can be seen in FIG. 2, the outlet opening faces downwards. The co-extrusion head 4 is configured to dispense a continuous structure 7 downwards, along an exit direction E which is vertical or substantially vertical. However, this condition is not necessary.

The apparatus 1 further comprises a moulding device, which, in the example shown, is conformed as a moulding carousel 8, shown in FIG. 1. The moulding carousel 8 is rotatable about a respective axis which, in the example illustrated, is arranged vertically. The moulding carousel 8 is provided, in a peripheral region thereof, with a plurality of moulds 9 each of which is configured to shape a dose of polymeric material in such a way as to obtain an object by compression moulding, the dose being obtained by cutting the continuous structure 7.

Between the co-extrusion head 4 and the moulding carousel 8 a transport device 10 is interposed, which, in the example shown, is conformed as a transport carousel. The transport device 10 comprises a plurality of transport elements 11, more clearly visible in FIG. 2, each of which is arranged to transport, towards the moulding carousel 8, a dose 12 of polymeric material which has been severed from the polymeric material coming out from the dispensing device 2.

As described in more detail below, the transport device 10 may also be configured to move away from the moulds 9 the objects formed by compression moulding the doses 12.

As shown in FIG. 2, the transport device 10 comprises a central body 13 that, in the example illustrated, is conformed as a drum having a substantially cylindrical geometry. The central body 13 is rotatable about an axis Z owing to a motor device that is not shown. The axis Z may be substantially vertical.

The transport elements 11 are supported by the central body 13, in a peripheral region of the latter.

When the central body 13 rotates about the axis Z, the transport elements 11 move along a path directed from the dispensing device 2 towards the mould 9, in order to bring the dose 12 to the mould 9. This movement defines a first movement of the transport elements 11. In the example shown, the path which the transport elements 11 follow during the first movement is a closed path, in particular a circular path about the axis Z. In an alternative embodiment not illustrated, the path of the transport elements 11 directed from the dispensing device 2 towards the mould 9 could be a closed non-circular path, or a non-closed path, for example linear.

The closed non-circular path is particularly suitable if it is desired that the path of the transport elements 11 overlaps the path of the moulds 9 not only at one point, but in a portion of greater length. This allows the transport element 11 to remain superposed on an element of the mould 9 (more precisely, on a male mould element, as described in more detail below), for a sufficiently long time to ensure that the dose 12 is released in the mould 9 without positioning defects.

Each transport element 11 is also configured to perform, in addition to the first movement and during the first movement, a second movement by rotating about an axis of the transport element 11, which is denoted by H in FIG. 2 and shown only for one transport element 11. This second movement makes it possible to modify the orientation of the dose 12, as described in more detail below.

In order to perform the second movement, in the example illustrated, each transport element 11 is supported by a support 14. A plurality of supports 14 is provided, the supports 14 being positioned in a peripheral region of the central body 13. More specifically, the supports 14 are mounted on a lateral surface of the central body 13. The supports 14 are fixed relative to the central body 13. Each support 14 may have an ‘L’ shape. Each peripheral support 14 supports a transport element 11, rotatably fixed to the peripheral support 14 by means of a pin 15. Each pin 15 extends along the respective axis H.

Each axis H is positioned transversely, in particular perpendicularly, relative to the axis Z. The axes H may lie in a single plane and can be, for example, arranged radially around the axis Z.

Each transport element 11 is delimited by a transport surface 16 intended to contact with the dose 12 for transporting the dose to the mould 9.

In the example shown the transport surface 16 is flat. This conformation of the transport surface 16 is particularly suitable for transporting doses 12 having a parallelepiped shape, as shown in FIG. 2. The transport surface 16 may however also have shapes which are not flat, for example be shaped as a portion of a cylinder, particularly if the dose 12 is not parallelepiped in shape.

The transport element 11 may be provided with a suction device, not shown, which can be activated selectively to retain the dose 12 in contact with the transport surface 16 during transport.

The transport element 11 may also be provided with a blowing device, not shown, which can be activated selectively to make easier detachment of the dose 12 from the transport surface 16, so that the dose 12 can be delivered to the mould 9.

In an embodiment which is not illustrated, instead of the blowing device or in combination with the latter, the transport element 11 may be provided with a sort of piston, i.e. a mechanical element which, at the suitable moment, pushes the dose 12 downwards, thereby helping the dose 12 to detach from the transport surface 16 to be released in the mould 9.

The transport element 11 may be provided with a thermal conditioning device, in particular conformed as a heating device, so as to prevent excessive cooling of the dose 12 during transport. Alternatively, the thermal conditioning device may be conformed as a cooling device to prevent an excessive adhesion of the dose 12 to the transport element 11, if the transport element 11 tends to overheat.

Each transport element 11 is associated with a movement device (not illustrated). The movement device, which may be, for example, housed in the central body 13, is suitable for rotating the transport element 11 about the respective axis H, so that the transport element 11 can perform the second movement.

In the example shown, the transport element 11 is positioned, for most of the path about the axis Z, in such a way that the transport surface 16 is facing downwards, in particular lying on a horizontal plane.

In a region of its path about the axis Z, the transport element 11 passes close to the dispensing device 2, in particular below the outlet opening of the co-extrusion head 4, from which the continuous structure 7 flows out.

Upstream of the dispensing device 2, the transport element 11 rotates about the respective axis H, thereby positioning itself in a collecting configuration P, shown in FIGS. 2 and 3, in which the transport element 11 collects a dose 12 separated from the continuous structure 7. In the collecting configuration P, the transport surface 16 may be directed vertically, or slightly backwards relative to the vertical direction.

Thus, the dose 12, which exits from the dispensing device along the substantially vertical exit direction E rests on the transport surface 16, which is also arranged substantially vertically, thereby adhering to the transport surface 16 owing to the viscosity of the polymeric material.

More generally, in the collecting configuration P, the transport element 11 is positioned in such a way that the transport surface 16 (or an axis thereof, if the transport surface 16 is shaped like a cylinder portion) is substantially parallel to the exit direction E of the dose 12 from the dispensing device 2.

The dose 12 is received from the transport element 11 in the collecting configuration P, whilst the dose 12 has a first orientation which in the example illustrated is substantially vertical. In an alternative embodiment, the dose 12 might have, in the collecting configuration P, a non-vertical orientation, for example because the exit direction E is not vertical.

After receiving the dose 12 in the collecting configuration P, whilst the transport element 11 is displaced about the axis Z by the central body 13 (first movement), the transport element 11 continues to rotate about the corresponding axis H (second movement). The transport element 11 rotates about the axis H until reaching a release configuration R, shown in FIG. 2, in which the dose 12 is released inside the mould 9, as described in more detail below. In the release configuration R, the transport surface 16 is facing downwards and may be, in particular, substantially horizontal.

In the release configuration R, the dose 12 has a second orientation which makes it suitable to be released in the mould 9.

After releasing the dose 12 in the mould element 9, the transport element 11 may remain in the release configuration R, that is to say, with the transport surface 16 facing downwards, until the transport element 11 returns close to the outlet opening of the dispensing device 2, and upstream of the latter.

The apparatus 1 further comprises at least one severing element for severing the doses 12 from the continuous structure 7.

In the example shown, there is provided a plurality of severing elements 17, each severing element 17 being associated with a transport element 11, in particular supported by the transport element 11. For example, each severing element 17 may be shaped like a cutting edge which delimits the transport surface 16.

When the severing element 17 passes beneath the outlet opening of the dispensing device 2, the severing element 17 cuts a dose 12, in particular by scraping the dose from the outlet opening. The dose 12 remains adhered to the transport element 11, particularly to the transport surface 16, so that it can be transported towards the mould 9.

The severing elements 17 may be of a shape different to that shown. For example, each severing element 17 might comprise a blade fixed to the transport element 11.

It is also possible to provide a severing element 17 independent of the transport elements 11, in particular a severing element positioned upstream of the transport elements 11 and separated by the latter, for example a blade which rotates in a position interposed between the dispensing device 2 and the transport elements 11, or a laser beam.

If the outlet opening has a rectangular or square shape, the dose 12 separated from the continuous structure 7 has a parallelepiped shape. In this case, a face of the parallelepiped, for example the face having the largest area with respect to the other faces, adheres to the transport surface 16 during transport of the dose 2 towards the mould 9.

If the continuous structure 7 is multi-layer, that is, formed by a plurality of layers of polymeric materials different from each other, the dose 12 separated from the continuous structure 7 also has a multi-layer conformation. In the example shown, the dose 12, as shown in FIGS. 2 and 9, has an intermediate layer 18, indicated in black in the drawings, interposed between two outer layers 19, indicated in white in the drawings. The intermediate layer 18 can be formed by a material having barrier properties, for example to oxygen, and/or gases, and/or light.

In the example shown the intermediate layer 18 has a flat conformation. Whilst the dose 12 is transported by the transport element 11, the intermediate layer 18 is parallel to the transport surface 16.

As shown in FIG. 9, the dose 12 may have a thickness S which is much less than its transversal dimensions L1 and L2, so as to be similar to a ‘wafer’. The transversal dimension L1 is measured along the exit direction E of the dose 12 from the dispensing device 2, whilst the transversal dimension L2 and the thickness S are measured transversely to that direction. The transversal dimensions L1 and L2 may be equal to each other.

In an embodiment that is not shown, the thickness S may be equal to one of the transversal dimensions L1 or L2. It is also possible that the thickness S is equal to both the transversal dimensions L1 and L2, in which case the dose is cubic.

In an alternative embodiment, the dose may have a dimension S which is greater the transversal dimensions L1 and L2. This version is particularly suitable for the case in which, due to the shape of the moulded object to be obtained, a mould cavity is used having a relatively small diameter with respect to the volume of the dose.

As shown in FIGS. 2 to 4, each mould 9 comprises a male mould element 20 and a female mould element 21, which are aligned with each other along a moulding axis Y, which may be vertical. The male mould element 20, which may be shaped like a punch, is arranged to form an inner surface of an object 22, shown in FIG. 4, which, in the example shown is a capsule for coffee. The female mould element 21 is arranged, on the other hand, to form an outer surface of the object 22. For this purpose, the female mould element 21 is provided with a forming cavity 23, shown in FIG. 4, in which the dose 12 is shaped.

Contrary to what happens in traditional machines, the male mould element 20 is positioned beneath the female mould element 21. The forming cavity 23 faces downwards.

The male mould element 20 has a transversal surface, configured for forming internally a base wall of the object 22.

A resting zone 24, shown in FIGS. 2 and 3, is defined on said transversal surface, for restingly receiving the dose 12 when the latter is released from the transport element 11.

The resting zone 24 is flat.

In the example shown, the resting zone 24 has a circular shape. It is however also possible to provide other shapes for the resting zone 24, which may be, for example, shaped like a circular crown or as a plurality of separate areas positioned, for example, along a circumference.

The resting zone 24 is arranged transversally, in particular perpendicularly, relative to the moulding axis Y. The resting zone 24 delimits an upper end portion of the male mould element 20. In other words, the resting zone 24 delimits the male mould element 20 at the top thereof.

The resting zone 24 may be substantially parallel to the transport surface 16, when the transport element 11 is in the release configuration R.

More specifically, the resting zone 24 may be substantially horizontal.

A movement system is associated with each mould 9 for mutually moving the male mould element 20 and the female mould element 21 between an open position P1, shown in FIGS. 2 to 4, and a closed position P2, shown in FIG. 4.

In the open position P1, the male mould element 20 and the female mould element 21 are spaced apart from each other and are positioned at the maximum distance from each other. In the open position P1, it is possible to introduce between the male mould element 20 and the female mould 21 a dose 12 released by a transport element 11. This occurs by interposing the transport element 11 between the male mould element 20 and the female mould element 21, in particular by positioning the transport element 11 above the male mould element 20, with the dose 12 adherent to the transport surface 16 and facing the resting zone 24.

In the closed position P2, between the male mould element 20 and the female mould element 21 a forming chamber is defined having a shape substantially corresponding to the object 22.

The movement system which allows each mould 9 to pass from the open position P1 to the closed position P2 or vice versa may be active on the male mould element 20, or on the female mould element 21, or on both.

In the example shown, the movement system is active on the male mould element 20, which is movable along the moulding axis Y in such a way as to move towards, or alternatively move away from, the female mould element 21.

The movement system may be of the hydraulic, mechanical or other type. In the example shown, the movement system comprises an actuator, particularly of the hydraulic type, to which is connected a stem 25. The male mould element 20 is fixed with respect to the stem 25. The actuator moves the stem 25 along the moulding axis Y, so that the male mould element 20 can be moved between a position of maximum distance from the female mould element 21 (in the open position P1 of the mould 9) or alternatively a position of minimum distance from the female mould element 21 (in the closed position P2 of the mould 9).

As shown in FIGS. 2 and 3, the apparatus 1 is so configured that, in the open position P1 of a mould 9, a transport element 11, arranged in the release configuration R, is interposed between the male mould element 20 and the female mould element 21 of the mould 9 in question. The transport element 11 is above the male mould element 20, with the dose 12 adhering to the transport surface 16 and facing the resting zone 24. In this configuration, the dose 12 may be released from the transport element 11 on the male mould element 20, so that the dose 12 rests on the resting zone 24.

The apparatus 1 is so configured that, when the mould 9 is in the open position P1 and the corresponding transport element 11 is in the release configuration R, the distance between the transport element 11 (in particular its transport surface 16) and the male mould element 20 (in particular its resting zone 24) is very small, only slightly greater than the thickness of the dose 12. It is also possible that this distance is equal to the thickness of the dose, or even slightly less than the latter.

This prevents the dose 12 from falling freely, or at least that the dose 12 does not fall freely for long distances, when it passes from the transport element 11 to the male mould element 20, so as to prevent or in any case minimize deformations and/or incorrect positioning of the dose 12.

The apparatus 1 further comprises a removal device 26, shown in FIG. 4, for removing from the mould 9 an object 22 just formed. The latter, after being obtained by compression moulding from the dose 12, remains associated with the female mould element 21.

The removal device 26 may comprise a supporting disc 27, capable of being interposed between the male mould element 20 and the female mould element 21 for restingly receiving the objects 22 which fall from the overlying female mould elements 21. More specifically, the supporting disc 27 is configured to be interposed between the male mould element 20 and the female mould element 21 in the open position P1 of the corresponding mould 9.

The removal device 26 may further comprise a plurality of removal elements 28, for example connected to each other in such a way as to form a star conveyor, each removal element 28 being positioned in such a way as to push an object 22 resting on the supporting disc 27 towards an outlet not illustrated.

The removal elements 28 are rotatable relative to the supporting disc 27, in such a way that the objects 22, pushed by the removal elements 28, slide above of the supporting disc 27.

More specifically, the removal elements 28 are rotatable about the axis Z of the central body 13, about which the transport elements 11 also rotate. For this purpose, the star conveyor defined by the removal elements 28 may be coaxial with respect to the central body 13. However, this condition is not necessary. The star conveyor mentioned above may not be coaxial with the central body 13.

The star conveyor defined by the removal elements 28 may be rotated by the same motor device which moves the central body 13 of the transport device 10, in such a way that the central body 13 and the star conveyor rotate as one.

The supporting disc 27 is positioned above the transport device 10, in particular above of the central body 13, in such a way that, whilst an object 22 falls from a female mould element 21 on the supporting disc 27, a dose 12 can be deposited on the male mould element 20 of the mould 9 in question.

A containment edge 29 projects from the support disc 27 upwards, to prevent the objects 22 from falling from the support disc 27.

In an alternative embodiment that is not illustrated, the removal device 26 may be absent. In this case, the object 22 may detach from the female mould element 21 and fall on the back of a transport element 11, that is to say, on a surface of the transport element 11 opposite the transport surface 16. This occurs whilst the transport element 11 is interposed between the male mould element 20 and the female mould element 21 to release a new dose 12 on the male mould element 20. The transport element 11 then moves the object 22 away from the mould 9 in which the latter has been formed, owing to the first movement of the transport element 11.

During operation, a continuous structure 7, comprising, for example, a plurality of layers of polymeric material, is dispensed by the dispensing device 2 and comes out from the outlet opening of the latter along the exit direction E, as shown in FIG. 2. The layers which form the continuous structure 7 lie in respective planes parallel to each other and to the exit direction E.

The central body 13 of the transport device 10 rotates, for example continuously, about the axis Z. The transport elements 11 supported by the central body 13 therefore move along a closed path, which, in the example shown is shaped like a circle centered on the axis Z. This is the first movement of the transport elements 11.

The path of the transport elements 11 passes beneath the outlet opening of the dispensing device 2 in a dispensing zone in which the doses 12 are dispensed.

Upstream of the dispensing zone, each transport element 11 rotates about the corresponding axis H, so as to be in the collecting configuration P, when the transport element 11 is below the outlet opening of the dispensing device 2. In this configuration, the transport element 11 interacts with the continuous structure 7, from which a dose 12 is separated owing to the severing element 17. The latter cuts the dose 12, in particular immediately below the outlet opening. The dose 12 rests on the transport surface 16, which is positioned parallelly, or almost parallelly, to a surface of the dose 12 facing the transport surface 16.

In the collecting configuration P, the transport surface 16 is furthermore positioned parallelly, or almost parallelly, to the intermediate layer 18 of the dose 12.

The transport surface 16 has an area greater than the surface of the dose 12 facing the transport surface 16.

The dose 12 is collected by the transport element 11 whilst the dose 12 has a first orientation, which, in the example shown is substantially vertical. The dose 12 adheres to the transport surface 16 without undergoing significant deformations. The intermediate layer 18 also remains substantially non-deformed.

The transport element 11 now moves away from the dispensing device 2 while carrying with it the dose 12, which remains adherent to the transport surface 16 owing to its viscosity and, if necessary, owing to the suction device of the transport element 11, which hold the dose in contact with the transport surface 16.

Simultaneously, the transport element 11 continues to rotate about the respective axis H, thereby modifying orientation of the dose 12 until moving the dose 12 to a second orientation in the release configuration R. This is the second movement of the transport element 11. In the release configuration R, the transport surface 16 of the transport element 11 is facing downwards and is in particular oriented horizontally, like the dose 12 adhering to it.

While passing from the collecting configuration P to the release configuration R, the dose 12 is thus turned from the first orientation to the second orientation.

The path of the transport element 11 overlaps the path of the moulds 9 at least in one point, in which the dose 12 is released from the transport element 11 on the male mould element 20.

In this point, the transport element 11 is in the release configuration R and is furthermore interposed between the male mould element 20 and the female mould element 21, which are in the open position P1.

The transport element 11 now releases the dose 12 which it is transporting. The dose 12 is deposited on the male mould element 20, in particular on the resting zone 24 which delimits the top of the latter. This may occur with the help of a blowing device or of a mechanical element, which acts on the dose 12 so as to detach it from the transport surface 16.

It should be noted that the resting zone 24 is horizontal, that is to say, parallel to the surface of the dose 12 facing it, when the dose 12 is in the second orientation (corresponding to the release configuration R). The resting zone 24 of the male mould element 20 is furthermore parallel to the transport surface 16 of the transport element 11, when the latter is in the release configuration R.

Thus, deformations of the dose 12 occurring when the dose passes from the transport element 11 to the male mould element 10 are minimized.

Moreover, when the transport element 11 is in the release configuration R (corresponding to the second orientation of the dose 12), the distance between the dose 12 and the resting zone 24 of the male mould element 20 is minimal, or even zero. The transport element 11 is therefore configured to place the dose 12 on the resting zone 24 without there being a free fall, that is to say, an uncontrolled fall, of the dose 12 from the transport element 11. The transport element 11 allows the position of the dose 12 to be controlled until the latter passes onto the male mould element 20. This also makes it possible to avoid unwanted deformations of the dose 12, which could adversely affect the correct positioning of the dose 12 on the resting zone 24.

The dose 12 can be positioned correctly on the resting zone 24 also owing to its parallelepiped shape. As more clearly shown in FIG. 5 (but this is also applicable to the preceding Figures), the dose 12 is delimited by a plurality of flat faces, including a lower face 30 intended to rest on the resting zone 24 of the male mould element 20. The flat shape the lower face 30 allows the dose 12 to be more stably rested on the resting zone 24, with respect to the case of a dose having a rounded shape.

The stability of the dose 12 is increased when, as in the example illustrated, the dose 12 has a thickness S which is less than, even significantly, its transversal dimensions L1 and L2. This makes it possible to lower the position of the barycenter of the dose 12, when the latter is resting on the male mould element 20.

As a consequence of the above, it is possible—in the majority of cases—to correctly position the dose 12 on the male mould element 20.

In more detail, the dose 12 may be easily positioned on the male mould element 20 in such a way that its lower face 30 is substantially horizontal.

Moreover, the dose 12 can easily be positioned in a centered manner on the male mould element 20.

This therefore produces good quality objects 22, inside of which the central layer 18 is uniformly distributed. Reference is made, in this regard, to FIGS. 7 and 8, which show an object 22, conformed as a capsule for coffee, obtained by means of the apparatus 1.

It may be noted in FIG. 7 that the material of the central layer 18, indicated in black, does not appear on the outer surface of the object 22.

FIG. 8 shows a plan view of the object 22 in which, in the upper half, the distribution of the material of the central layer 18 has been highlighted in black. It should be noted that the material is uniformly distributed also in an upper flange 31 of the object 22, the upper flange 31 being opposite to a respective base wall 32, which confirms that the material of the central layer 18 is distributed in a uniform manner in the entire object 22.

The appearance of the object 22 is also improved with respect to the prior art.

In this regard, it has been experimentally verified that the apparatus 1 described above allows objects 22 to be obtained without spots on the outer surface of the object.

Indeed, possible spots due to rapid cooling of the regions of the dose which first contact the mould are formed on the inner surface of the object 22 and are not therefore visible during its normal use.

Any spots due to a not very delicate handling of the dose, particularly during cutting and transport, are absent in the objects products by means of the apparatus 1, since the combination of the transport element 11 which rotates the dose 12 from the first orientation to the second orientation, and of the male mould element 20 located under the female mould element 21 allows deformations (such as wrinkles) of the dose to be minimized and allows the dose to be treated in a much less stressful manner with respect to the state of the art.

The treatment of dose is even less stressful if the transport elements 11 are heated whilst they transport the dose 12 from the dispensing device 2 to the mould 9. In this case, it has been surprisingly found that spots are not formed on the outer surface of the objects 22, not even when the objects 22 are made with particularly critical materials, such as polypropylene (PP).

The precision which the apparatus 1 makes it possible to obtain as regards the positioning of the dose 12 on the male mould element 20, also allows the transversal dimensions L1 and L2 of the dose 12 to be maximized. As shown in FIG. 5 (but this is also applicable to the preceding Figures), these dimensions can be slightly smaller, equal to or larger than the dimensions the base wall of the object 22, that is to say, than the transversal dimensions of the upper end of the male mould element 20. This makes it possible to optimize the filling the mould 9, since the polymeric material forming the dose 12 is able to reach more rapidly even the zones of the forming chamber furthest from the resting zone 24.

On the contrary, in the apparatuses according to the prior art, if the transversal dimensions of the dose are too close to the dimensions of the bottom wall of the moulded object, the dose risks being positioned in a tilted manner (as is the case of FIG. 16), with consequent asymmetric distribution of the barrier material in the moulded object (as shown in FIGS. 17 and 18). For this reason, in the apparatuses according to the prior art, it is often necessary to use doses having transversal dimensions much smaller than the dimensions of the base wall of the object, which in any case involves drawbacks due to an incorrect distribution of the layers, as described above with reference to FIGS. 10 to 12.

In an embodiment, shown in FIGS. 5 and 6, there is provided a control device, in particular a vision system 33 which may be provided with a video camera, for checking the position of the dose 12 on the male mould element 20.

The vision system 33 allows the position of the dose 12 to be inspected when the mould 9 is still open, that is to say, when the male mould element 20 is still spaced from the female mould element 21 and the dose 12 is still un-deformed. For this purpose, the vision system 33 may be positioned at a point of the path of the mould 9, in which the latter is still open.

The vision system 33 is configured to check if the dose 12 has been released in a centered position on the male mould element 20, that is to say, if an axis of the dose, perpendicular, for example, to its bottom face 30, is coaxial relative to a longitudinal axis of the male mould element 20.

In addition or alternatively to the above, the vision system 33 is configured to check if the dose 12, after being released by the transport element 11, has been positioned in a tilted manner, in particular not horizontally, on the male mould element 20, that is to say, if its bottom face 30 is parallel to the resting zone 24.

If one or both of these conditions are not met, the control device may be configured to generate an alarm, in order to inform the operators supervising the apparatus 1 regarding the incorrect positioning condition of the dose 12. In addition to the generation of the alarm, the control device may be configured to stop the apparatus 1, or to reject the object 22 formed starting from the incorrectly positioned dose 12.

FIG. 5 shows a situation in which the dose 12 is correctly positioned on the male mould element 20, whilst in the case of FIG. 6 the dose 12 is positioned in an off-centre and tilted manner on the resting zone 24.

It should be noted that the vision system 33 may easily check the position of the dose 12 when the mould 9 is still open, since in the open position P1, or in a position close to the open position P1, the visibility of the dose 12, deposited on the male mould element 20, it is not obstructed by the walls of the forming cavity included in the female mould element 21. These walls are still far away, and, more specifically, at a higher level than the dose 12.

If, on the other hand, the dose had been deposited inside the forming cavity of the female mould element, as occurs in the prior art, the side walls of the forming cavity would have obstructed the viewing of the dose, positioned on the bottom of the cavity, by any vision system.

1. An apparatus comprising:
a dispensing device for dispensing at least one polymeric material;
a severing element for severing a dose of polymeric material from the polymeric material dispensed by the dispensing device;
a transport element for transporting the dose;
a mould comprising a male mould element and a female mould element, the female mould element being positioned above the male mould element;
wherein the transport element is configured to perform a first movement by moving along a path directed from the dispensing device towards the mould, so as to bring the dose to the mould,
and wherein the transport element is configured to perform, in addition to the first movement, a second movement by rotating about an axis, so as to turn the dose from a first orientation with which the dose is received by the transport element, to a second orientation with which the dose is released by the transport element onto the male mould element.

2. An apparatus according to claim 1, wherein the dispensing device is configured to dispense a dose having a parallelepiped shape, an upper end of the male mould element being delimited by a substantially flat resting zone arranged for restingly receiving a flat lower face of the dose.

3. An apparatus according to claim 2, wherein the transport element is positionable in a release configuration in which the dose, arranged in the second orientation, is delivered to the male mould element, the transport element being delimited by a transport surface intended to contact the dose, the transport surface being flat and substantially parallel to the resting zone in the release configuration.

4. An apparatus according to claim 2, wherein the transport element is positionable in a release configuration in which the dose, arranged in the second orientation, is delivered to the male mould element, the transport element being arranged, in the release configuration, at a distance from the resting zone, said distance being substantially equal to a thickness of the dose, so as to avoid an uncontrolled falling of the dose from the transport element to the male mould element.

5. An apparatus according to claim 1, and further comprising a vision system for controlling how the dose is resting on an upper end of the male mould element, the vision system being so positioned as to inspect the mould while the mould is in an open position in which a forming cavity of the female mould element is at a level higher than the dose, so that the female mould element does not obstruct visibility of the dose by the vision system.

6. An apparatus according to claim 5, wherein the vision system is so configured as to control centring and/or inclination of the dose with respect to the upper end of the male mould element.

7. An apparatus according to claim 1, wherein the dispensing device comprises a co-extrusion head for dispensing a continuous multilayer coextruded structure, from which multi-layer doses may be severed.

8. An apparatus according to claim 1, wherein the transport element is provided with a thermal conditioning device for thermally conditioning the dose during transport from the dispensing device towards the mould.

9. An apparatus according to claim 1, wherein the transport element is provided with a detachment device for promoting detachment of the dose from the transport element, so that the dose can fall on the male mould element, the detachment device being selected from a group comprising: a blowing device, a mechanical pushing element, or a combination of these.

10. An apparatus according to claim 1, wherein the axis about which the dispensing device is rotatable during the second movement is positioned transversely with respect to a further axis about which the path of the transport element during the first movement extends at least partially.

11. An apparatus according to claim 1, and further comprising a removal device having a surface which can be inserted beneath the female mould element for restingly receiving an object formed from the dose, the object falling from the female mould element when the mould is opened.

12. An apparatus according to claim 11, wherein the removal device comprises a star conveyor positioned above a central body, the transport element being supported at a peripheral region of the central body.

13. An apparatus according to claim 1, and further comprising a movement system active on the male mould element for moving the male mould element towards the female mould element, or alternatively for moving the male mould element away from the female mould element.
